(19) United States
(12) Patent Application Publication
(10) Pub. No.: US 2013/0179165 A1
(43) Pub. Date: Jul. 11, 2013

(54) DYNAMIC PRESENTATION AID

(71) Applicants: Jeffrey T. Holman, Farmington, UT (US); Darrin E. Burnham, Kettering, OH (US)

(72) Inventors: Jeffrey T. Holman, Farmington, UT (US); Darrin E. Burnham, Kettering, OH (US)

(21) Appl. No.: 13/740,070

(22) Filed: Jan. 11, 2013

Related U.S. Application Data
(60) Provisional application No. 61/585,555, filed on Jan. 11, 2012.

(51) Int. Cl. G10L 15/26

(52) U.S. Cl. CPC G10L 15/265
USPC 704/235

(57) ABSTRACT

Performing operations for dynamic display element management. The operations include receiving a verbal input. The operations also include automatically obtaining a display element from an element repository. The display element is a graphical representation of at least a portion of the verbal input. The display element includes a graphical image having a plurality of characteristics. The operations also include evaluating at least one of the plurality of characteristics relative to a present state of a display. The operations also include sending the display element to the display based on the evaluation of the present state of the display.

### BACKGROUND

Visual, audio, and tactile perception is an effective aid to verbal communication. Communications such as video conference calls and slide-based presentations incorporate stimuli supplementary to the verbal communication. One disadvantage to most conventional systems is that these stimuli must be prepared and organized before conveying the verbal communication. Additionally, most systems have little flexibility during the presentation process.

### SUMMARY

Embodiments of the invention relate to a computer program product. The computer program product includes a computer readable storage medium to store a computer readable program. The computer readable program, when executed by a processor within a computer, causes the computer to perform operations for dynamic display element management. The operations include receiving a verbal input. The operations also include automatically obtaining a display element from an element repository. The display element is a graphical representation of at least a portion of the verbal input. The display element includes a graphical image having a plurality of characteristics. The operations also include evaluating at least one of the plurality of characteristics relative to a present state of a display. The operations also include sending the display element to the display based on the evaluation of the present state of the display. Other embodiments of the computer program product are also described.

Embodiments of the invention also relate to a dynamic story-telling device. The device includes an input receiver, an image retrieval engine, and an image management engine. The input receiver receives at least a portion of a verbal story. The image retrieval engine retrieves an image from an image location. The image represents a key word derived from the at least a portion of the verbal story received at the input receiver. The image management engine dynamically manages a display. The image management engine prepares the retrieved image for display relative to a current display state and prepares the current display state to accommodate the retrieved image to provide a visual composition representing a corresponding portion of the verbal story. Other embodiments of the device are also described.

Embodiments of the invention also relate to a method for generating a dynamic presentation aid. The method includes receiving a verbal input. The method also includes automatically obtaining a presentation element from an element repository. The presentation element is representative of at least a portion of the verbal input. The presentation element has a plurality of characteristics. The method also includes comparing at least one of the plurality of characteristics of the presentation element with a corresponding characteristic of a presentation space. The method also includes sending the presentation element to the presentation space based on a result of the comparison of the at least one of the plurality of characteristics. Other embodiments of the method are also described.

### BRIEF DESCRIPTION OF THE DRAWINGS

FIG. 1 illustrates a block diagram of one embodiment of a dynamic presentation aid device.

FIGS. 2A-D illustrate several stages of a dynamic presentation generation process.

FIG. 3 illustrates a flow chart diagram of one embodiment of a method for generating a dynamic presentation aid.

Throughout the description, similar reference numbers may be used to identify similar elements.

### DETAILED DESCRIPTION

In the following description, specific details of various embodiments are provided. However, some embodiments may be practiced with less than all of these specific details. In other instances, certain methods, procedures, components, structures, and/or functions are described in no more detail than to enable the various embodiments of the invention, for the sake of brevity and clarity.

It will be readily understood that the components of the embodiments as generally described herein and illustrated in the appended figures could be arranged and designed in a wide variety of different configurations. Thus, the following more detailed description of various embodiments, as represented in the figures, is not intended to limit the scope of the present disclosure, but is merely representative of various embodiments. While the various aspects of the embodiments are presented in drawings, the drawings are not necessarily drawn to scale unless specifically indicated.

The present invention may be embodied in other specific forms without departing from its spirit or essential characteristics. The described embodiments are to be considered in all respects only as illustrative and not restrictive. The scope of the invention is, therefore, indicated by the appended claims rather than by this detailed description. All changes which come within the meaning and range of equivalency of the claims are to be embraced within their scope.

Reference throughout this specification to features, advantages, or similar language does not imply that all of the features and advantages that may be realized with the present invention should be or are in any single embodiment of the invention. Rather, language referring to the features and advantages is understood to mean that a specific feature, advantage, or characteristic described in connection with an embodiment is included in at least one embodiment of the present invention. Thus, discussions of the features and advantages, and similar language, throughout this specification may, but do not necessarily, refer to the same embodiment.

Furthermore, the described features, advantages, and characteristics of the invention may be combined in any suitable manner in one or more embodiments. One skilled in the relevant art will recognize, in light of the description herein, that the invention can be practiced without one or more of the specific features or advantages of a particular embodiment. In other instances, additional features and advantages may be recognized in certain embodiments that may not be present in all embodiments of the invention.

In some embodiments, the software portions are stored in a non-transitory state such that the software portions, or representations thereof, persist in the same physical location for a period of time. Additionally, in some embodiments the software portions are stored on one or more non-transitory storage devices, which include hardware elements capable of storing non-transitory states and/or signals representative of the software portions, even though other portions of the non-transitory storage devices may be capable of altering and/or transmitting the signals. One example of a non-transitory storage device includes a read-only memory (ROM) which can store signals and/or states representative of the software portions for a period of time. However, the ability to store the signals and/or states is not diminished by further functionality of transmitting signals that are the same as or representative of the stored signals and/or states. For example, a processor may access the ROM to obtain signals that are representative of the stored signals and/or states in order to execute the corresponding software instructions.

Reference throughout this specification to “one embodiment,” “an embodiment,” or similar language means that a particular feature, structure, or characteristic described in connection with the indicated embodiment is included in at least one embodiment of the present invention. Thus, the phrases “in one embodiment,” “in an embodiment,” and similar language throughout this specification may, but do not necessarily, all refer to the same embodiment. Additionally, the phrase “image” is used throughout the description of various embodiments; however, this language should not be read so as to limit the present invention to only images in any embodiment. The phrase “image” is used as images are likely a more common application; however, movie, sound, and other media files can also form a portion of the present invention.

Embodiments of the design are expected to be user friendly and be adaptable to a plurality of different electronic devices. The simplicity of the design provides for ease of use. Embodiments of the design may be implemented on personal electronic devices to facilitate personal use. In some embodiments, the design provides for dynamic generation of presentation aids. In one embodiment, the design allows a user to generate a visual, audio, and textual aid for an improvised children's story. In another embodiment, the design allows a user to generate a visual, audio, and textual aid for a group presentation or communication. Other embodiments may generate aids for other communication situations.

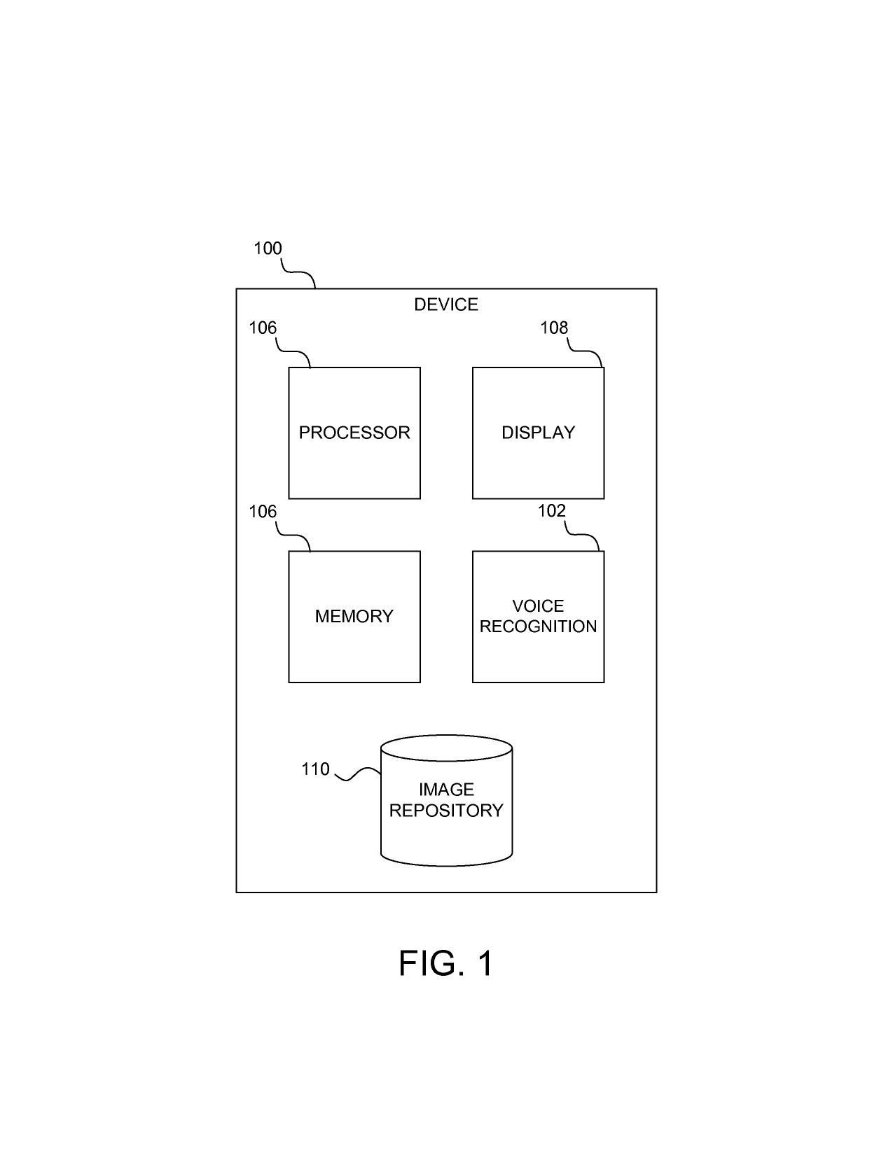

FIG. 1 illustrates a block diagram of one embodiment of a dynamic presentation aid device 100. While other embodiments may have other arrangements with more or fewer components, the illustrated device 100 includes a voice recognition engine 102, a memory 104, a processor 106, a display 108, and an image repository 110. The voice recognition engine 102 captures audio in the form of voice signals in the vicinity of the device 100. In some embodiments, the voice recognition engine 102 is coupled to an external microphone (not shown). In some embodiments, the voice recognition engine 102 stores captured audio files to the memory 104. In some embodiments, the voice recognition engine 102 performs a function on the captured audio files prior to storing at the memory 104. For example, the voice recognition engine 102 may identify a keyword or phrase within the captured audio files or reduce the audio files to a plurality of potential keywords. Alternatively, the processor 106 performs some or all of the processing on the voice files after the input voice is stored in digital format. Known techniques for voice recognition and language analysis may be used in conjunction with embodiments described herein.

The memory 104 is coupled to the voice recognition engine 102 to receive audio or other data from the voice recognition engine 102. In some embodiments, the memory 104 also stores operating instructions for one or more components of the device 100. In particular, the memory 104 may store operating instructions for the processor 106.

In some embodiments, the processor 106 reads the audio files stored on the memory 104 and processes the audio files to discover a keyword. The processor 106 may also analyze the audio files to discover a contextual setting for the audio data to generate relationships between keywords. For example, the processor 106 may determine that one keyword has priority over another chronologically or in within the context of the voice input. In some embodiments, the processor 106 retrieves an image from the image repository 110 or other files from the memory 104 (or other location) based on the data identified from the audio files (keywords, context, etc.). For example, the processor 106 may retrieve an image of a dog from the image repository 110 based on identification of the keyword “dog.” The processor 106 also may retrieve an image of a person from a remote network repository based on a keyword of “man.” Remote network repositories may include dedicated storage devices to serve images to one or more devices 100. Additionally, remote network repositories may include image servers with commonly available image content.

In some embodiments, the processor 106 sends the retrieved image to the display 108. In some embodiments, the processor 106 analyzes the current state of the display 108 for files currently on the display 108. If the processor 106 finds that an existing image is already displayed on the display 108, the processor 106 enters an image management process. In the image management process, the processor 106 may modify the current image on the display 108 and/or the image to be displayed on the display 108. For example, the processor 106 may discover that the current image on the display 108 is too large to allow the image to be displayed to fit on the display 108 simultaneously. In response, the processor 106 may resize either or both images to fit the dimensions of the screen. In other embodiments, the processor 106 may overlap the images based on a priority determination for the images relative to one another. Other embodiments may incorporate other functionality in the processor 106.

While some embodiments provide for all processes to be carried out local to the device 100, other embodiments may execute some or all of the processes described herein through external components. In some embodiments, some or all of the functionality of the processor 106 may be implemented in a cloud-based system. In other embodiments, the image, instruction, and/or voice files accessed by the processor 106 may be stored on a network or other separate location. Other embodiments may access fewer or more components through a network or other external connection. Additionally, multiple processing devices may be provided, and some of the processing devices may perform dedicated functions. For example, a graphics processing unit may be dedicated to processing the graphical elements for display on the display 108. Other embodiments may utilize other shared or dedicated processing resources.

In some embodiments, the display 108 may be any type of graphical display devices such as a touch screen or other visual display. In some embodiments, the display 108 includes an audio component for generating sounds. The display 108 is coupled to the processor 106 to receive and display graphical images. In some embodiments, the display 108 includes a projector element to project the display onto a surface. The display 108 may also include a tactile element. For example, the display 108 may include a vibration feature. Other embodiments of the display 108 include other communication features to communicate data to a user.

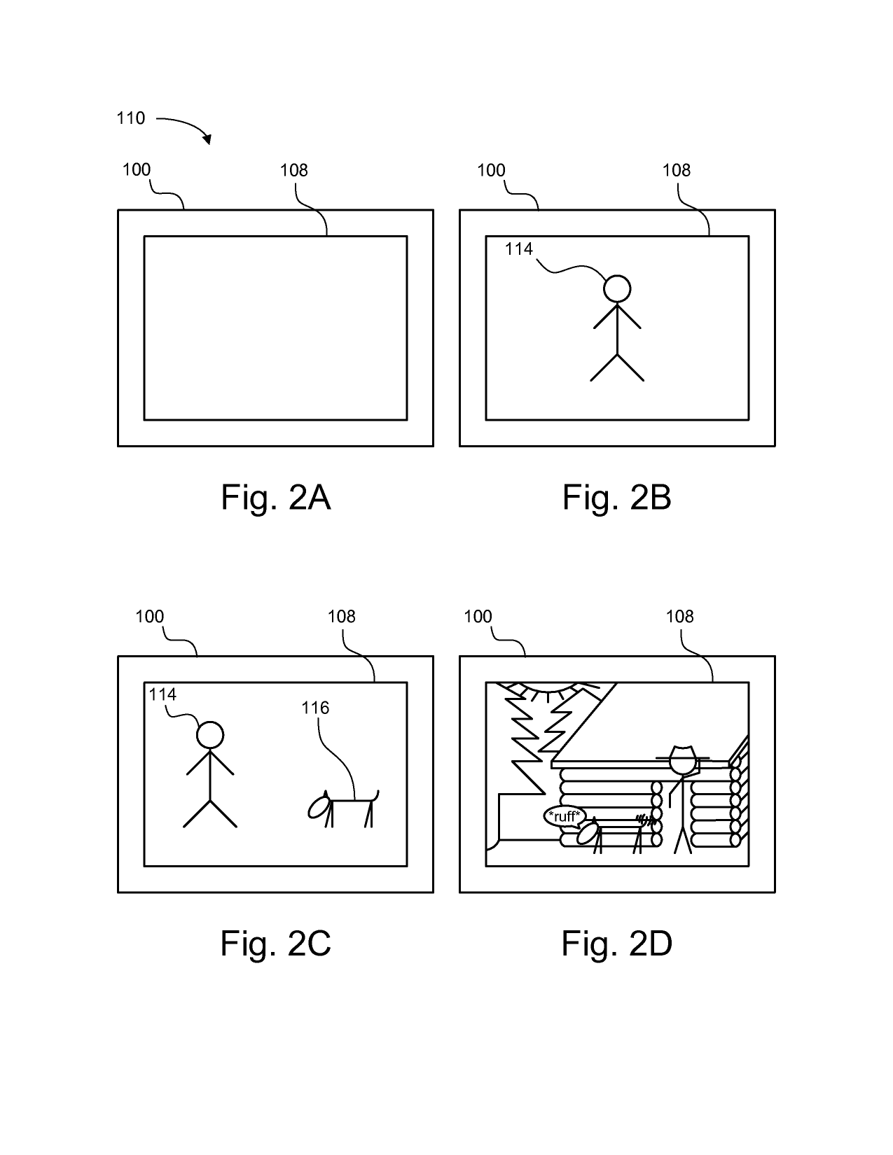

FIGS. 2A-D illustrate several stages of a dynamic presentation generation process. For convenience, several aspects of the dynamic presentation generation process are described within the context of a mobile application (or “app”) which operates on a mobile device. The app also may have any number of typical controls, menu selections, interfaces, and so forth as are typically available for mobile apps. Tablets, smart phones, and other personal media players are examples of devices which run apps, although other types of computing devices may run a software application to accomplish the same or similar functionality as described herein. Portions of the app may be implemented on an app server that is remote from the display device, while other portions may be implemented at the display device.

In some embodiments, the app dynamically displays images as the user tells a story. The story may be unknown to the app beforehand, as in the case of a parent telling a story to a child at bedtime. As the story progresses, the app recognizes and analyzes the language of the story to identify key words and triggers for image selection and display. Thus, as the user tells the story, characters or other graphical elements may be dynamically retrieved, configured, and displayed corresponding to the content of the story. In some embodiments, automation may be used to reconfigure some or all of the existing graphical elements when a new graphical element is to be added. Additionally, automation may be used to determine when a page is “full” and when to begin a new “page” of images in the story. In this way, the images and pages of the story are produced and displayed as a dynamic visual enhancement to the story, or other presentation, that is being shared.

As a very simple, but non-limiting, example of functionality that may be provided in embodiments of the device 100, the following short story will be referenced as verbal input to the device 100.
Once upon a time, there was a boy. The boy had a dog. The boy loved to play with the dog outside. One day the boy traveled with the dog to a cabin in the woods. When it was daytime, they would go outside and play. The dog was so excited that it would wag its tail and bark.

In FIG. 2A, the device 100 has a blank display 108 prior to receiving or processing the verbal input. In some embodiments, before starting, the display 108 may display an introductory image or other phrase. For example, the display may show text such as “Once upon a time . . .” or an open book with empty pages. Alternatively, the device 100 may activate a sound such as music or a book opening or pages turning. In the illustrated embodiment, a user may tap the screen, push a button, or provide verbal input to begin. In some embodiments, once the application is started the user need only speak to begin.

For the sake of convenience, the following table identifies keywords that may be gleaned from the verbal input segments provided above. Although the segments are shown corresponding to complete sentences, other embodiments may use verbal input segments that are longer or shorter than a complete sentence. Also, in the table only new keywords are shown for each segment of the verbal input-keywords previously identified are not repeated for subsequent segments of the verbal input.

| Verbal Input Segments | Key Word(s) |
|---|---|
| Once upon a time, there was a boy. | boy |
| The boy had a dog. | dog |
| The boy loved to play with the dog outside. | play, outside |
| One day the boy traveled with the dog to a cabin | day, traveled, cabin, |
| in the woods. | woods |
| When it was daytime, they would go outside and | daytime, go |
| play. | |
| The dog was so excited that it would wag its tail | excited, wag, tail, |
| and bark. | bark |

In some embodiments, several words or phrases may be processed together, prior to retrieving and displaying corresponding images. In other embodiments, the process of retrieving and displaying corresponding images may be more elaborately intermixed with the process of receiving and analyzing the verbal input, which may result in more dynamic transformations of the images on the display.

In one embodiment, at least some of the identified keywords are used to retrieve and display corresponding images. Other keywords may be temporarily or permanently ignored in response to a determination that there is not a corresponding image or a corresponding image is not needed or trivially useful. In some instances, the decision to use or ignore a keyword may depend on the current state of the display 108, including the presence of existing graphical elements already shown on the display 108.

In the illustrated embodiment of FIG. 2B, the display 108 displays a graphical element 114 representative of a person. The person is displayed in response to identification of the keyword “boy” within the first verbal input segment. In some embodiments, the specific graphical element 114 used to represent the boy is selected from a plurality of available images which are associated (through metadata or otherwise) with the keyword “boy” or a synonym or other related term. In some embodiments, the device 100 identifies the graphical element 114 based on metadata attached to the graphical element 114 that describes at least one characteristic of the image. In general, the images stored on the image repository 110 may be organized into categories or types, with a variety of hierarchical or other arrangements. Other embodiments may use other image management and identification processes.

In some embodiments, the graphical element 114 representing the person is retrieved and resized or otherwise adjusted to correspond with the display 100. Additionally, the one or more parameters of the graphical element 114 may be configured to correspond with other keywords or phrases within the verbal input. For example, the person may be shown with a particular eye color or type of clothing.

In FIG. 2C, the device 100 displays another graphical element 116 corresponding to the keyword “dog” within the second segment of the verbal input. In order to accommodate the graphical element 116 of the dog, the device 100 may adjust one or more parameters of the first graphical element 114. In particular, in the illustrated example, the first graphical element 114 of the person is moved to the left in order to show the second graphical element 116 of the dog on the right side of the display 108.

In one embodiment, the device 100 determines display parameters for at least two of the graphical elements at the same time. For example, the device 100 may analyze and configure parameters such as size, resolution, clarity, location, priority, color, setting (day, night, city, country, season, etc.), perspective, background, language, culture, or other characteristics of the image, sound, or other display element.

In some embodiments, the images are displayed with a standard transition or animation. In other embodiments, the user may specify a certain effect, allow the device 100 to select one based on the keyword or history, or generate a random effect for each image.

In the illustrated embodiment of FIG. 2D, the display 108 is further modified to accommodate additional graphical elements, including a hat on the person and a background environment with a cabin, woods, and the sun. As an example, the hat and the sun may be shown in response to the “daytime” keyword. Similarly, the cabin and woods may be shown in response to the “cabin” and “woods” keywords. Additionally, other presentation elements may be added in response to the keywords. For example, an animation of the dog wagging its tail may be added in response to the combined “wag” and “tail” keywords, and an audio playback operation may be executed in response to the “bark” keyword. Other embodiments may implement any number and combination of presentation elements, including visual, tactile, audible, olfactory, or other sensory feedback, depending on the capabilities of the device 100.

In the specific example described herein, some of the keywords are ignored or dismissed. In particular, the keywords “play,” “day,” “traveled,” and “excited” do not have corresponding unique graphical elements or other presentation elements. However, the determination of which keywords (or phrases or other input segments) might get corresponding presentation elements may depend on the context of the overall story, or presentation, that is presented to the device 100, as well as the availability of display space or capabilities.

As can be seen from the figures, the graphical elements may be arranged in a z-order relative to one another on the display 108. The z-order refers to which graphical elements are shown “on top of” other graphical elements. In FIG. 2D, the person and dog have a higher z-order and, consequently, are shown in front of the background cabin, woods, and sun. The z-order of each graphical element may be determined dynamically, based on the presence of other graphical elements already on the display 108. Additionally, some indication of the z-order (or a default z-order) of a particular graphical element may be provided in the metadata of the graphical element.

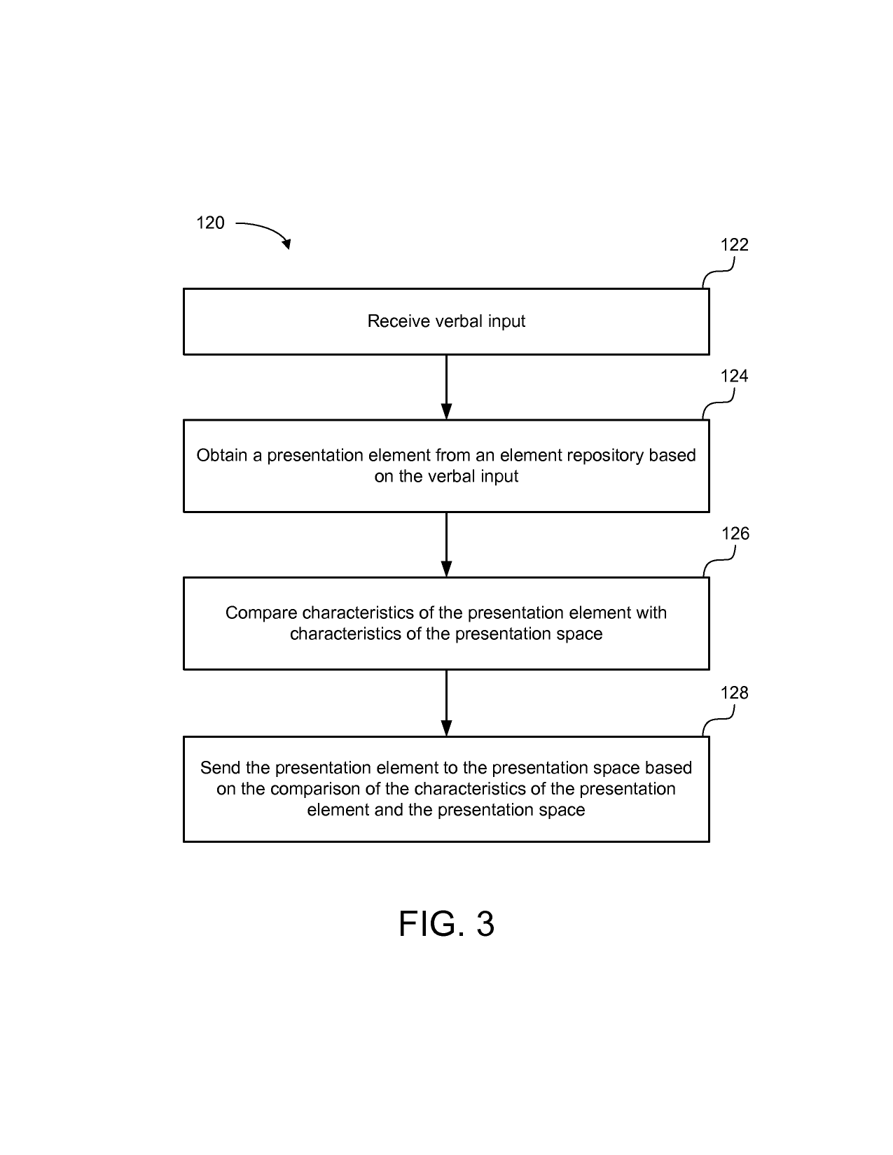

FIG. 3 illustrates a flow chart diagram of one embodiment of a method 120 for generating a dynamic presentation aid. At block 122, the device 100 receives a verbal input. At block 124, the device 100 obtains a presentation element from an element repository based on the verbal input received. At block 126, the device 100 compares characteristics of the presentation element with characteristics of the presentation space. Accordingly, the device 100 may modify one or more characteristics or parameters of the retrieved presentation element to fit with the present conditions of the presentation space. At block 128, the device 100 sends the presentation element to the presentation space based on the comparison of the characteristics of the presentation element and the presentation space. The depicted method 120 then ends.

In another embodiment, the device 100 may provide story prompts to the user to stimulate progression of the story. The story prompts may be in any format and may be automatically generated or manually requested by the user. In another embodiment, a user may manually modify one or more characteristics of a graphical element after it is retrieved and displayed. For example, a user may resize the graphical element through one or more user commands or menu selections. In another embodiment, the user may request a new graphical element if the retrieved graphical element is not satisfactory. For example, in one embodiment, the user may implement a touchscreen command to dynamically replace the unsatisfactory graphical element with another randomly or specifically selected graphical element. In another embodiment, the user may populate some or all of the image repository with his or her own images. For example, a parent user may use a child's artwork as the images for a story.

An embodiment of a dynamic presentation aid includes at least one processor coupled directly or indirectly to memory elements through a system bus such as a data, address, and/or control bus. The memory elements can include local memory employed during actual execution of the program code, bulk storage, and cache memories which provide temporary storage of at least some program code in order to reduce the number of times code must be retrieved from bulk storage during execution.

It should also be noted that at least some of the operations for the methods may be implemented using software instructions stored on a computer useable storage medium for execution by a computer. As an example, an embodiment of a computer program product includes a computer useable storage medium to store a computer readable program that, when executed on a computer, causes the computer to perform operations, including operations to dynamically recognize a keyword, identify an graphical element related to the keyword, retrieve the graphical element from an image repository, detect a state of a display, and display the graphical element on the display.

Embodiments of the invention can take the form of an entirely hardware embodiment, an entirely software embodiment, or an embodiment containing both hardware and software elements. In one embodiment, the invention is implemented in software, which includes but is not limited to firmware, resident software, microcode, etc.

Furthermore, embodiments of the invention can take the form of a computer program product accessible from a computer-usable or computer-readable medium providing program code for use by or in connection with a computer or any instruction execution system. For the purposes of this description, a computer-usable or computer readable medium can be any apparatus that can contain, store, communicate, propagate, or transport the program for use by or in connection with the instruction execution system, apparatus, or device.

The computer-useable or computer-readable medium can be an electronic, magnetic, optical, electromagnetic, infrared, or semiconductor system (or apparatus or device), or a propagation medium. Examples of a computer-readable medium include a semiconductor or solid state memory, magnetic tape, a removable computer diskette, a random access memory (RAM), a read-only memory (ROM), a rigid magnetic disk, and an optical disk. Current examples of optical disks include a compact disk with read only memory (CD-ROM), a compact disk with read/write (CD-R/W), and a digital video disk (DVD).

Input/output or I/O devices (including but not limited to keyboards, displays, pointing devices, etc.) can be coupled to the system either directly or through intervening I/O controllers. Additionally, network adapters also may be coupled to the system to enable the data processing system to become coupled to other data processing systems or remote printers or storage devices through intervening private or public networks. Modems, cable modems, and Ethernet cards are just a few of the currently available types of network adapters.

In the above description, specific details of various embodiments are provided. However, some embodiments may be practiced with less than all of these specific details. Although specific embodiments of the invention have been described and illustrated, the invention is not to be limited to the specific forms or arrangements of parts so described and illustrated. The scope of the invention is to be defined by the claims appended hereto and their equivalents.

Although the operations of the method(s) herein are shown and described in a particular order, the order of the operations of each method may be altered so that certain operations may be performed in an inverse order or so that certain operations may be performed, at least in part, concurrently with other operations. In another embodiment, instructions or sub-operations of distinct operations may be implemented in an intermittent and/or alternating manner.

Although specific embodiments of the invention have been described and illustrated, the invention is not to be limited to the specific forms or arrangements of parts so described and illustrated. The scope of the invention is to be defined by the claims appended hereto and their equivalents.

What is claimed is:

1. A computer program product, comprising:
a computer readable storage medium to store a computer readable program, wherein the computer readable program, when executed by a processor within a computer, causes the computer to perform operations for dynamic display element management, the operations comprising:
receiving a verbal input;
automatically obtaining a display element from an element repository, wherein the display element is a graphical representation of at least a portion of the verbal input, the display element comprising an graphical image having a plurality of characteristics;
evaluating at least one of the plurality of characteristics relative to a present state of a display; and
sending the display element to the display based on the evaluation of the present state of the display.

2. The computer program product of claim 1, wherein the computer program product, when executed by the processor within the computer, causes the computer to perform additional operations comprising changing a display parameter of an existing element to accommodate displaying the display element simultaneously with the existing element.

3. The computer program product of claim 2, wherein changing the display parameter of the existing element comprises resizing the existing element.

4. The computer program product of claim 1, wherein the computer program product, when executed by the processor within the computer, causes the computer to perform additional operations comprising applying an animation effect applied to at least a portion of the existing element in response to further verbal input.

5. The computer program product of claim 2, wherein changing the display parameter of the existing element comprises changing a color of the existing element.

6. The computer program product of claim 2, wherein changing the display parameter of the existing element comprises changing an overlay order of the display element with respect to the existing element.

7. The computer program product of claim 1, wherein the computer program product, when executed by the processor within the computer, causes the computer to perform additional operations comprising detecting at least one key word from the verbal input and identifying the display element based on the at least one key word.

8. The computer program product of claim 1, wherein evaluating at least one of the plurality of characteristics relative to the present state of the display comprises checking for an existing element currently on the display and comparing at least one display parameter of the existing element with the at least one plurality of characteristics of the display element in response to detection of the existing element in the present state of the display.

9. A dynamic story-telling device, comprising:
an input receiver to receive at least a portion of a verbal story;
an image retrieval engine to retrieve an image from an image location, the image representing a key word derived from the at least a portion of the verbal story received at the input receiver; and
an image management engine to dynamically manage a display, wherein the image management engine is configured to prepare the retrieved image for display relative to a current display state and to prepare the current display state to accommodate the retrieved image to provide a visual composition representing the at least a portion of the verbal story.

10. The device of claim 9, wherein the image management engine is configured to check for an existing image in the current display state and, in response to detection of an existing image, change a display parameter of the existing image to facilitate displaying the retrieved image on the display.

11. The device of claim 9, wherein the image management engine is configured to check for an existing image in the current display state and, in response to detection of an existing image, change a display parameter of the retrieved image to facilitate displaying the retrieved image on the display.

12. The device of claim 10, wherein changing a display parameter of the existing image comprises resizing at least one of the existing image and the retrieved image.

13. The device of claim 10, wherein changing a display parameter of the existing image comprises changing a color.

14. The device of claim 9, wherein the image retrieval engine is configured to analyze the at least a portion of the verbal story to derive the key word.

15. A method for generating a dynamic presentation aid, the method comprising:
receiving a verbal input;
automatically obtaining a presentation element from an element repository, wherein the presentation element is representative of at least a portion of the verbal input, the presentation element having a plurality of characteristics;
comparing at least one of the plurality of characteristics of the presentation element with a corresponding characteristic of a presentation space; and
sending the presentation element to the presentation space based on a result of the comparison of the at least one of the plurality of characteristics.

16. The method of claim 15, further comprising dynamically changing a display parameter of at least one of the presentation element and an existing element within the presentation space to generate a composite presentation representative of the verbal input.

17. The method of claim 16, wherein dynamically changing the display parameter of at least one of the presentation element and the existing element within the presentation space comprises resizing at least one of the presentation element and the existing element.

18. The method of claim 16, wherein dynamically changing the display parameter of at least one of the presentation element and the existing element within the presentation space comprises changing a color of at least one of the presentation element and the existing element.

19. The method of claim 16, wherein dynamically changing the display parameter of at least one of the presentation element and the existing element within the presentation space comprises changing an overlay order of at least one of the presentation element and the existing element.

20. The method of claim 16, further comprising applying an animation effect to at least a portion of at least one of the presentation element and the existing element.
